(19) United States
(12) Patent Application Publication
(10) Pub. No.: US 2007/0262198 A1
(43) Pub. Date: Nov. 15, 2007

(54) Flying machine

(76) Inventor: Avudainayagam Subbiah, Hyderabad (IN)

Correspondence Address: A. SUBBIAH, PLOT NO 28. VASANTNAGAR, KUKATPALLY, HYDERABAD, ANDRA PRADESH, 500072, IN

(21) Appl. No.: 10/800,797

(22) Filed: Nov. 18, 2004

(51) Int. Cl. B64C 29/04

(52) U.S. Cl. 244/23 C

(57) ABSTRACT

The new type of flying machine will be of circular in shape. This is made up of two (concave) dishes joined at the circumference with hollow space in between them. A number of specially designed jets or nozzles are fixed round the circumference. The propellant force is ejected through the number of tangentially fixed nozzles (jets) fixed around the circumference. High pressure air/gas ejected through these nozzles, tangentially will impart a high speed rotary motion to the disc, at very high speeds, the disc will start flying at a very high speed. The main claim is the method of getting are borne with the help of high speed notary discs/dishes.

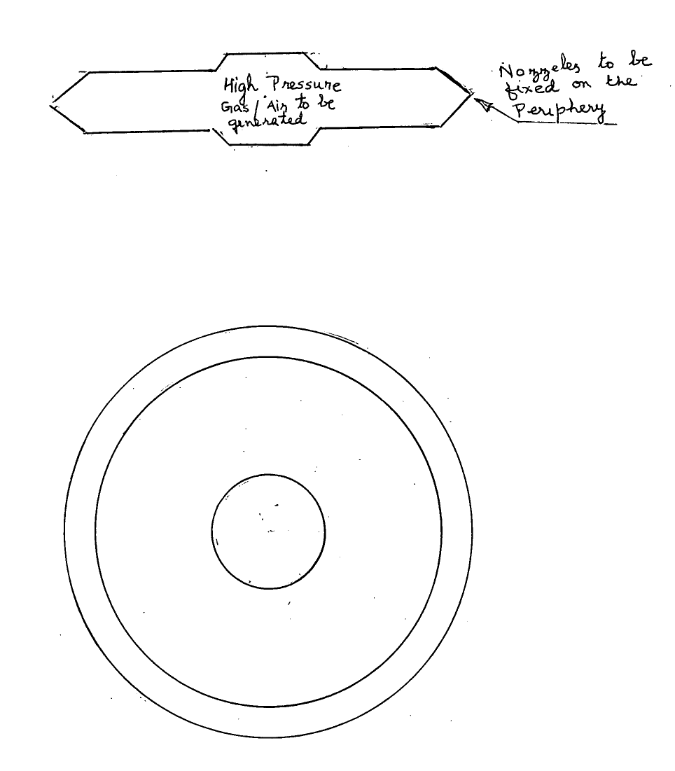

The flying object is to be made of two hollow discs welded on the circumference.

### DRAWING ENCLOSED SEPARATELY

A number of nozzles are to be fixed around the circumference. The nozzles are fixed in such a manner that high pressure gas/air will leave tangentially to the disc. When high pressure gas/air leaves tangentially this force will impart a high speed rotary motion to the disc. When the speed increases and at very high speeds the disc will leave the ground and start flying at a high speed.

This main idea of the high speed revolving disc leaving the ground and taking off is the main claim and this idea is to be patented.

In order to impart the high speed rotary motion, it is necessary to generate high pressure gas or air inside the hollow potion. The material of construction of the discs should be able to withstand a high pressure and temperature.

This is the basic principle. Later this can be also achieved by simulating the escape of the gas by a micro processor controlled valve. In this case only gas/air will be ejected through the nozzles in a circular fashion controlled by the valve. In this case the disc will leave the ground and take off without any rotary motion.

The above is roughly the basic principle of imparting the main propelling force. The pay load and control gears are to be mounted in a separate cabin mounted on a central stationary pivot.

1. This main idea of the high speed-revolving disc leaving the ground and taking off is the main claim and this idea is to be patented.

2. Claim No. 1 can be also achieved by simulating the escape of the gas/air by a micro processor controlled valve. In this case only gas/air will be ejected through the nozzles in a circular fashion controlled by the valve. In this case the disc will leave the ground and take of without any rotary motion.
